(19) United States
(12) Patent Application Publication
(10) Pub. No.: US 2012/0277368 A1
(43) Pub. Date: Nov. 1, 2012

(54) AQUEOUS DISPERSION PRESSURE-SENSITIVE ADHESIVE COMPOSITION AND PRESSURE-SENSITIVE ADHESIVE SHEET

(75) Inventors: Masatsugu KOSO, Osaka (JP); Katsuhiko KAMIYA, Osaka (JP); Hironao OOTAKE, Osaka (JP)

(73) Assignee: NITTO DENKO CORPORATION, Osaka (JP)

(21) Appl. No.: 13/458,329

(22) Filed: Apr. 27, 2012

(30) Foreign Application Priority Data
Apr. 28, 2011 (JP) 2011-101801

(51) Int. Cl. C09J 133/10

(52) U.S. Cl. 524/560

(57) ABSTRACT

The present invention relates to an aqueous dispersion pressure-sensitive adhesive composition containing: an acrylic emulsion polymer (A); and a compound (B) in which the compound (B) has a solubility in water (25° C.) of 1 g/100 g or more, and has, in the molecule, at least one nitrogen atom and two or more substituents represented by the following formula (1) and bonded to the nitrogen atom:

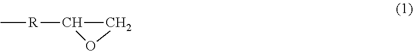

(wherein R represents a divalent group selected from the group consisting of linear or branched alkylene having a carbon number of 1 to 10, phenylene, alkyl group-substituted phenylene, halogen-substituted phenylene, and heteroatom-containing alkylene).

### TECHNICAL FIELD

The present invention relates to an aqueous dispersion pressure-sensitive adhesive composition. More specifically, the present invention relates to an aqueous dispersion pressure-sensitive adhesive composition which can form a pressure-sensitive adhesive layer containing substantially no organic solvent and being excellent in appearance characteristics and capable of maintaining pressure-sensitive adhesive characteristics for a long period of time. The present invention also relates to a pressure-sensitive adhesive sheet having a pressure-sensitive adhesive layer formed of the aqueous dispersion pressure-sensitive adhesive composition.

### BACKGROUND ART

Conventionally, a solvent-type pressure-sensitive adhesive has been used as a pressure-sensitive adhesive. However, since the solvent-type pressure-sensitive adhesive contains an organic solvent, volatilization of the solvent during coating brings about a problem in terms of global environment or working environment. Therefore, a switch to an aqueous dispersion pressure-sensitive adhesive using no organic solvent is being attempted.

As the aqueous dispersion pressure-sensitive adhesive (or aqueous dispersion pressure-sensitive adhesive composition), a pressure-sensitive adhesive composition using an oil-soluble crosslinking agent (non-water-soluble crosslinking agent) in view of reactivity or pot life of the crosslinking agent solution is known. For example, an aqueous dispersion acrylic pressure-sensitive adhesive composition for re-detachment, containing an oil-soluble crosslinking agent is known (see, Patent Documents 1 and 2). However, at the time of adding a small amount of an oil-soluble crosslinking component to an aqueous dispersion pressure-sensitive adhesive, when the oil-soluble crosslinking compound is directly added and mixed to the aqueous dispersion pressure-sensitive adhesive without diluting to produce an aqueous dispersion pressure-sensitive adhesive composition, and a pressure-sensitive adhesive layer is produced using this aqueous dispersion pressure-sensitive adhesive composition, a dent or a gel (gel material) is generated on the surface of the pressure-sensitive adhesive layer in some cases. The presence of a dent or a gel may disadvantageously give rise to an appearance defect of the final product. Also, at the production of an aqueous dispersion pressure-sensitive adhesive composition by adding an oil-soluble crosslinking component to an aqueous dispersion pressure-sensitive adhesive, when the oil-soluble crosslinking component is diluted with an organic solvent and then added, mixing with an aqueous dispersion pressure-sensitive adhesive in producing an aqueous dispersion pressure-sensitive adhesive composition may be performed easily, but a pressure-sensitive adhesive sheet having a pressure-sensitive adhesive layer obtained by coating and drying this aqueous dispersion pressure-sensitive adhesive composition sometimes disadvantageously suffers from the possibility that the organic solvent may remain in the pressure-sensitive adhesive layer. Furthermore, in the case where the oil-soluble crosslinking component is a component slightly dissolvable in water, at the production of an aqueous dispersion pressure-sensitive adhesive composition by adding the component to an aqueous dispersion pressure-sensitive adhesive, when the crosslinking component is diluted with water and then added to an aqueous dispersion pressure-sensitive adhesive, the diluted solution to be added becomes a thin diluted solution because of low solubility of the crosslinking component in water and therefore, the viscosity of the obtained aqueous dispersion pressure-sensitive adhesive composition is reduced. When the viscosity of the aqueous dispersion pressure-sensitive adhesive composition as a coating solution is reduced, at the production of a pressure-sensitive adhesive sheet, repelling (for example, the coating solution is not spread on a substrate and the coating solution is repelled by the substrate) may occur to deteriorate the coating appearance in some cases.
Patent document 1: JP-A-2004-91563
Patent Document 2: JP-A-2006-169496

### SUMMARY OF THE INVENTION

An object of the present invention is to provide an aqueous dispersion pressure-sensitive adhesive composition which can form a pressure-sensitive adhesive layer containing substantially no organic solvent and being excellent in appearance characteristics (appearance failure is reduced) and capable of maintaining pressure-sensitive adhesive characteristics for a long period of time. Another object of the present invention is to provide a pressure-sensitive adhesive sheet having a pressure-sensitive adhesive layer formed of the pressure-sensitive adhesive composition.

As a result of intensive studies to attain the above-described objects, the present inventors have found that when an acrylic emulsion polymer and a specific compound are used as constituent components, an aqueous dispersion pressure-sensitive adhesive composition which can form a pressure-sensitive adhesive layer containing substantially no organic solvent and being excellent in appearance characteristics and capable of maintaining pressure-sensitive adhesive characteristics for a long period of time, can be obtained. The present invention has been accomplished based on this finding.

That is, the present invention provides an aqueous dispersion pressure-sensitive adhesive composition comprising:

an acrylic emulsion polymer (A); and

a compound (B),

wherein the compound (B) has a solubility in water (25° C.) of 1 g/100 g or more, and has, in the molecule, at least one nitrogen atom and two or more substituents represented by the following formula (1) and bonded to the nitrogen atom:

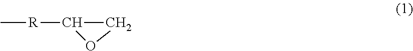

(wherein R represents a divalent group selected from the group consisting of a linear or branched alkylene group having a carbon number of 1 to 10, a phenylene group, an alkyl group-substituted phenylene group, a halogen-substituted phenylene group, and a heteroatom-containing alkylene group).

The molar ratio of epoxy group of the compound (B) per mol of a functional group capable of reacting with the epoxy group of the compound (B) in the acrylic emulsion polymer (A) is preferably from 0.003 to 3.10, and more preferably from 0.015 to 0.922.

The R in the formula (1) is preferably a divalent group selected from the group consisting of a linear or branched alkylene group having a carbon number of 1 to 5, a phenylene group, an alkyl group-substituted phenylene group, a halogen-substituted phenylene group, and a heteroatom-containing alkylene group; more preferably a divalent group selected from the group consisting of a linear or branched alkylene group having a carbon number of 1 to 5 and a heteroatom-containing alkylene group having a carbon number of 1 to 5; further preferably a divalent group selected from the group consisting of a linear or branched alkylene group having a carbon number of 1 to 5; and particularly preferably methylene group.

The R in the formula (1) is preferably a divalent group selected from the group consisting of a linear or branched alkylene group having a carbon number of 1 to 10.

The number of epoxy groups contained in the compound (B) is preferably from 3 to 5, and more preferably 3.

The compound (B) has the solubility in water (25° C.) of preferably 10 g/100 g or more, and more preferably 30 g/100 g or more.

The acrylic emulsion polymer (A) is preferably formed of a mixture of raw material monomers comprising: a (meth)acrylic acid alkyl ester and a carboxyl group-containing unsaturated monomer, in which the content of the (meth)acrylic acid alkyl ester is preferably from 70 to 99.5 wt % and the content of the carboxyl group-containing unsaturated monomer is preferably from 0.5 to 20 wt %, based on the total weight of the raw material monomers constituting the acrylic emulsion polymer (A).

The compound (B) is preferably N,N,N-tri(2,3-epoxypropyl)amine.

Further, the present invention provides a pressure-sensitive adhesive sheet having a pressure-sensitive adhesive layer formed of the above-mentioned aqueous dispersion pressure-sensitive adhesive composition.

The aqueous dispersion pressure-sensitive adhesive composition of the present invention is an aqueous dispersion-type and has the above-described configurations, and therefore the pressure-sensitive adhesive layer formed of the aqueous dispersion pressure-sensitive adhesive composition and the pressure-sensitive adhesive sheet having the pressure-sensitive adhesive layer contain substantially no organic solvent and are excellent in appearance characteristics and capable of maintaining pressure-sensitive adhesive characteristics for a long period of time. The phrase “a pressure-sensitive adhesive layer contains substantially no organic solvent” as used herein means that the content of organic solvent in the pressure-sensitive adhesive layer is 3 wt % or less, preferably 2 wt % or less, and further preferably 1 wt % or less.

### MODE FOR CARRYING OUT THE INVENTION

### Aqueous Dispersion Pressure-Sensitive Adhesive Composition

The aqueous dispersion pressure-sensitive adhesive composition of the present invention contains at least an acrylic emulsion polymer (A) and a compound (B). The term “aqueous emulsion” as used herein means to be dispersible in an aqueous medium. That is, the aqueous dispersion pressure-sensitive adhesive composition of the present invention is a pressure-sensitive adhesive composition dispersible in an aqueous medium. The aqueous medium is a medium (dispersion medium) containing water as an essential component and may be water alone or a mixture of water and a water-soluble organic solvent. The aqueous dispersion pressure-sensitive adhesive composition of the present invention is preferably a liquid dispersion using water.

The acrylic emulsion polymer (A) is a polymer constituted by using an acrylic monomer as an essential raw material monomer (raw material monomer component) and, among others, is preferably a polymer constituted by using a (meth)acrylic acid alkyl ester and a carboxyl group-containing unsaturated monomer as essential raw material monomers. The acrylic emulsion polymer (A) may comprise, if desired, a monomer component used for the purpose of imparting functionality other than those described above (a monomer component other than a (meth)acrylic acid alkyl ester and a carboxyl group-containing unsaturated monomer), as raw material monomer component. That is, the acrylic emulsion polymer (A) is preferably a polymer obtained from a monomer mixture containing a (meth)acrylic acid alkyl ester and a carboxyl group-containing unsaturated monomer as essential components. As for the acrylic emulsion polymer (A), one polymer may be used alone, or two or more polymers may be used in combination. Here, the “(meth)acryl” indicates “acryl” and/or “methacryl” (either one or both of “acryl” and “methacryl”).

In the above raw material monomers, the (meth)acrylic acid alkyl ester is used as a main monomer component and fulfills a role mainly to develop basic characteristics as a pressure-sensitive adhesive (or a pressure-sensitive adhesive layer), such as adhesiveness and releasability (re-detachability). The (meth)acrylic acid alkyl ester is not particularly limited, but examples thereof include a (meth)acrylic acid alkyl ester having a linear, branched or cyclic alkyl group with a carbon number of 2 to 16 (preferably from 2 to 10 and more preferably from 4 to 8).

The acrylic acid alkyl ester is preferably an acrylic acid alkyl ester having an alkyl group with a carbon number of 2 to 14 (more preferably from 4 to 9). Specific preferred examples thereof include an acrylic acid alkyl ester having a linear or branched alkyl group, such as n-butyl acrylate, isobutyl acrylate, s-butyl acrylate, isoamyl acrylate, hexyl acrylate, heptyl acrylate, octyl acrylate, 2-ethylhexyl acrylate, isooctyl acrylate, nonyl acrylate, and isononyl acrylate; and an alicyclic acrylic acid alkyl ester such as cyclohexyl acrylate, bornyl acrylate and isobornyl acrylate. Among these, 2-ethylhexyl acrylate and n-butyl acrylate are particularly preferred.

The methacrylic acid alkyl ester is preferably a methacrylic acid alkyl ester having an alkyl group with a carbon number of 2 to 16 (more preferably from 2 to 10). Specific examples thereof include a methacrylic acid alkyl ester having a linear or branched alkyl group, such as ethyl methacrylate, propyl methacrylate, isopropyl methacrylate, n-butyl methacrylate, isobutyl methacrylate, s-butyl methacrylate, and t-butyl methacrylate; and an alicyclic methacrylic acid alkyl ester such as cyclohexyl methacrylate, bornyl methacrylate and isobornyl methacrylate.

The (meth)acrylic acid alkyl ester can be appropriately selected according to the intended adherence or the like. One of these (meth)acrylic acid alkyl esters may be used alone, or two or more thereof may be used in combination.

The content of the (meth)acrylic acid alkyl ester in the raw material monomers constituting the acrylic emulsion polymer (A) is from 70 to 99.5 wt % and preferably from 85 to 99.5 wt %, based on the total weight (entire amount, 100 wt %) of the raw material monomers (all raw material monomers) constituting the acrylic emulsion polymer (A). If the content exceeds 99.5 wt %, the content of the carboxyl group-containing unsaturated monomer in the raw material monomers is decreased and this causes reduction in anchoring property and low contamination property of the pressure-sensitive adhesive layer formed of the pressure-sensitive adhesive composition or causes reduction in stability of the emulsion, whereas if the content is less than 70 wt %, adhesiveness and re-detachability of the pressure-sensitive adhesive layer formed of the pressure-sensitive adhesive composition may be reduced in some cases. The content ratio (content of acrylic acid alkyl ester:content of methacrylic acid alkyl ester) between the acrylic acid alkyl ester and the methacrylic acid alkyl ester in the (meth)acrylic acid alkyl ester is not particularly limited but is preferably from 100:0 to 30:70 (by weight) and more preferably from 100:0 to 50:50.

In the raw material monomers, the carboxyl group-containing unsaturated monomer forms a protective layer on the surface of an emulsion particle formed of the acrylic emulsion polymer (A) and prevents shear fracture of the emulsion particle. This effect is more enhanced by neutralizing the carboxyl group with a base. Incidentally, the stability of the emulsion particle against shear fracture is more commonly referred to as mechanical stability. Also, when a polyfunctional compound (polyfunctional epoxy compound, particularly the compound (B)) capable of reacting with a carboxyl group is mixed in a one-liquid or two-liquid form, the carboxyl group-containing unsaturated monomer can act as a crosslinking point during the stage of forming a pressure-sensitive adhesive layer by removing water. Furthermore, the adherence (anchoring property) between the pressure-sensitive adhesive layer and a substrate can be enhanced through the compound (B) that is a polyfunctional compound.

The carboxyl group-containing unsaturated monomer is not particularly limited, and examples thereof include a (meth)acrylic acid (acrylic acid and methacrylic acid), itaconic acid, maleic acid, fumaric acid, crotonic acid, carboxyethyl acrylate, and carboxypentyl acrylate. The carboxyl group-containing unsaturated monomer as used herein includes also an acid anhydride group-containing unsaturated monomer such as maleic anhydride and itaconic anhydride. Among these, a (meth)acrylic acid is preferred, and an acrylic acid is more preferred, because the relative concentration on the emulsion particle surface is high and a protective layer with a higher density is readily formed. One of these carboxyl group-containing unsaturated monomers is used alone, or two or more thereof are used in combination.

The content of the carboxyl group-containing unsaturated monomer is not particularly limited but is preferably from 0.5 to 20 wt % and more preferably from 1 to 5 wt %, based on the total weight (100 wt %) of the raw material monomers (all raw material monomers) constituting the acrylic emulsion polymer (A). If the content exceeds 20 wt %, since the carboxyl group-containing unsaturated monomer (for example, an acrylic acid) is generally water-soluble, this monomer is sometimes polymerized in water to cause thickening (increase of viscosity). Furthermore, after forming the pressure-sensitive adhesive layer, interaction of the pressure-sensitive adhesive layer with an adherend may be increased to intensify adhesive force with aging and make the separation difficult in some cases. On the other hand, if the content is less than 0.5 wt %, mechanical stability of the emulsion particle may be reduced or adherence (anchoring property) between the pressure-sensitive adhesive layer and a substrate may be decreased, giving rise to an adhesive deposit.

As the monomer constituting the acrylic emulsion polymer(A) for use in the present invention, a monomer component other than those essential components may be used in combination for the purpose of imparting a specific function.

For example, an amino group-containing unsaturated monomer may be contained in the raw material monomers constituting the acrylic emulsion polymer (A). The amino group-containing unsaturated monomer becomes a reaction point reacting with the crosslinking component and enhances cohesive force of emulsion particles. Examples of such an amino group-containing unsaturated monomer include aminoethyl (meth)acrylate, dimethylaminoethyl (meth)acrylate, and t-butylaminoethyl (meth)acrylate. One of these amino group-containing unsaturated monomers is used alone, or two or more thereof are used in combination.

The content of the amino group-containing unsaturated monomer is not particularly limited but is preferably from 0.1 to 10 wt % and more preferably from 0.1 to 5 wt %, based on the total weight (100 wt %) of the raw material monomers (all raw material monomers) constituting the acrylic emulsion polymer (A). If the content exceeds 10 wt %, cohesive force may become excessively high to deteriorate adhesive property of the pressure-sensitive adhesive layer formed of the pressure-sensitive adhesive composition.

Furthermore, as such a monomer component, for example, an amide group-containing monomer such as N,N-diethylacrylamide and N-isopropylacrylamide may be added in an amount of 0.1 to 10 wt % for the purpose of enhancing cohesive force. A (meth)acrylic acid aryl ester such as phenyl (meth)acrylate; a vinyl ester such as vinyl acetate and vinyl propionate; and a styrene-based monomer such as styrene may be added each in an amount of 0.1 to 5 wt % for the purpose of refractive index adjustment or reworking. Furthermore, an epoxy group-containing monomer such as glycidyl (meth)acrylate and allyl glycidyl ether; and a polyfunctional monomer such as trimethylolpropane tri(meth)acrylate and divinylbenzene may be added each in an amount of 0.01 to 2.0 wt %, for the purpose of enhancing crosslinking within an emulsion particle and enhancing cohesive force. The amount added here means the content based on the total amount (100 wt %) of the raw material monomer components constituting the acrylic emulsion polymer (A).

From the standpoint of more reducing self-contamination, smaller amount added of the hydroxyl group-containing unsaturated monomer as the other monomer components, such as 2-hydroxyethyl acrylate and 2-hydroxypropyl acrylate, is preferably. Specifically, the amount added of the hydroxyl group-containing unsaturated monomer is preferably less than 1 wt %, more preferably less than 0.1 wt %, and it is still more preferred to substantially not contain the monomer (for example, less than 0.05 wt %), based on the total weight (100 wt %) of the raw material monomers (all raw material monomers) constituting the acrylic emulsion polymer (A). However, in the case of intending to introduce a crosslinking point for crosslinking such as crosslinking between a hydroxyl group and an isocyanate group or metal crosslinking, this monomer may be added in an amount of 0.01 to 10 wt %.

In particular, the raw material monomers constituting the acrylic emulsion polymer (A) preferably contains at least a (meth)acrylic acid alkyl ester as a main component, a carboxyl group-containing unsaturated monomer, and an amino group-containing unsaturated monomer, from the standpoint of adjusting the solvent insoluble portion (gel portion) of the pressure-sensitive adhesive layer formed of the aqueous dispersion pressure-sensitive adhesive composition to thereby obtaining excellent coating appearance and excellent pressure-sensitive adhesive characteristics. In this connection, it is preferred that in the total weight of the raw material monomers constituting the acrylic emulsion polymer (A), the content of the (meth)acrylic acid alkyl ester is from 70 to 99.5 wt %, the content of the carboxyl group-containing unsaturated monomer is from 0.5 to 20 wt %, and the content of the amino group-containing unsaturated monomer is from 0 to 10 wt %. Incidentally, in the raw material monomer constituting the acrylic emulsion polymer (A), the amino group-containing unsaturated monomer may be contained or may not be contained.

The acrylic emulsion polymer (A) is obtained by emulsion-polymerizing the above-described raw material monomers (monomer mixture) by using an emulsifier and a polymerization initiator.

The emulsifier for use in the emulsion polymerization of the acrylic emulsion polymer (A) is not particularly limited but includes an emulsifier not containing a radical polymerizable functional group (hereinafter, sometimes referred to as “non-reactive emulsifier”) and an emulsifier containing a radical polymerizable functional group (hereinafter, sometimes referred to as “reactive emulsifier”). Incidentally, one of the emulsifiers may be used alone, or two or more thereof may be used in combination. Also, as the emulsifier, a non-reactive emulsifier and a reactive emulsifier may be used in combination.

Above all, the emulsifier is preferably a non-reactive emulsifier. Here, one of the non-reactive emulsifiers may be used alone or two or more thereof may be used in combination.

Examples of the non-reactive emulsifier include an anionic emulsifier such as alkylsulfate, alkylsulfonate, dialkylsulfosuccinate, and polyoxyethylene alkylether sulfate; and a nonionic emulsifier such as polyoxyethylene alkylphenol ether, polyoxyalkyl ether, and polyoxyethylene carboxylic acid ester.

Furthermore, as the non-reactive emulsifier, examples of the anion type include sodium dodecylbenzenesulfonate, sodium polyoxyethylene alkyl ether sulfate, and sodium alkylsulfonate, and examples of the nonionic type include a polyoxyethylene alkyl type, a polyoxyethylene alkyl ether type, a polyoxyethylene glycol type, and a polyoxyethylene propylene glycol type.

The emulsifier for use in the emulsion polymerization of the acrylic emulsion polymer (A) is preferably the above-described non-reactive emulsifier but may be a reactive emulsifier containing a radical polymerizable functional group.

The reactive emulsifier is an emulsifier having at least one radical polymerizable functional group in the molecule (per molecule). As the reactive emulsifier, for example, one member or two or more members selected from various reactive emulsifiers having a radical polymerizable functional group such as vinyl group, propenyl group, isopropenyl group, vinyl ether group (vinyloxy group), and allyl ether group (allyloxy group) are used. In the case where the emulsifier for use in the emulsion polymerization of the acrylic emulsion polymer (A) is a reactive emulsifier, the emulsion is incorporated into a polymer, and contamination derived from the emulsifier is reduced in the formed pressure-sensitive adhesive.

Examples of the reactive emulsifier include a reactive emulsifier having a configuration (or a reactive emulsifier corresponding to the configuration) in which a radical polymerizable functional group (radical reactive group) such as propenyl group and allyl ether group is introduced into a nonionic anionic emulsifier (an anionic emulsifier having a nonionic hydrophilic group) such as sodium polyoxyethylene alkyl ether sulfate, ammonium polyoxyethylene alkylphenyl ether sulfate, sodium polyoxyethylene alkylphenyl ether sulfate, and sodium polyoxyethylene alkyl sulfosuccinate. In the following, the reactive emulsifier having a configuration in which a radical polymerizable functional group is introduced into an anionic emulsifier is referred to as “anionic reactive emulsifier”. Also, the reactive emulsifier having a configuration in which a radical polymerizable functional group is introduced into a nonionic anionic emulsifier is referred to as “nonionic anionic reactive emulsifier”.

The blending amount (amount used) of the emulsifier is preferably from 0.1 to 5 parts by weight and more preferably from 0.5 to 3 parts by weight, per 100 parts by weight as the total weight of the raw material monomers (all raw material monomers) constituting the acrylic emulsion polymer (A). If the blending amount exceeds 5 parts by weight, cohesive force of the pressure-sensitive adhesive layer formed may be reduced to increase the amount of contamination on an adherend, or contamination due to the emulsifier may occur in the pressure-sensitive adhesive layer formed. Furthermore, adhesive force of the pressure-sensitive adhesive layer may be decreased, or foaming may be caused to produce a defect and thereby deteriorate coating appearance in some cases. On the other hand, if the blending amount is less than 0.1 parts by weight, stable emulsification may not be maintained in some cases.

The polymerization initiator for use in the emulsion polymerization of the acrylic emulsion polymer (A) is not particularly limited, but examples thereof include an azo-based polymerization initiator such as 2,2′-azobisisobutyronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropionamidine)disulfate, 2,2′-azobis(N,N′-dimethyleneisobutylamidine); a persulfate such as potassium persulfate and ammonium persulfate; a peroxide-based polymerization initiator such as benzoyl peroxide, t-butyl hydroperoxide and hydrogen peroxide; and a redox-type initiator by a combination of a peroxide and a reducing agent, such as a combination of a peroxide and ascorbic acid (e.g., combination of aqueous hydrogen peroxide and ascorbic acid), a combination of a peroxide and an iron(II) salt (e.g., combination of aqueous hydrogen peroxide and an iron(II) salt), and a combination of a persulfate and sodium hydrogensulfite.

The blending amount (amount used) of the polymerization initiator may be appropriately determined according to the kind of the initiator or raw material monomers and is not particularly limited, but, for example, the blending amount is preferably from 0.01 to 1 part by weight and more preferably from 0.02 to 0.5 parts by weight, per 100 parts by weight as the total weight of the raw material monomers (all raw material monomers) constituting the acrylic emulsion polymer (A).

In the polymerization of the acrylic emulsion polymer (A), a chain transfer agent may be used so as to adjust the molecular weight of the acrylic emulsion polymer (A). As the chain transfer agent, a conventionally known or commonly employed chain transfer agent can be used. Examples thereof include lauryl mercaptan, glycidyl mercaptan, mercaptoacetic acid, 2-mercaptoethanol, thioglycolic acid, 2-ethylhexyl thioglycolate, 2,3-dimercapto-1-propanol, 1-dodecanethiol, and t-dodecanethiol. One chain transfer agent may be used alone, or two or more chain transfer agents may be used in combination. The blending amount (amount used) of the chain transfer agent is not particularly limited but is preferably from 0.001 to 0.5 parts by weight per 100 parts by weight as the total weight of the raw material monomers (all raw material monomers) constituting the acrylic emulsion polymer (A).

The polymerization method for the emulsion polymerization of the acrylic emulsion polymer (A) is not particularly limited, and examples thereof include general batch polymerization, continuous dropping polymerization and portionwise dropping polymerization.

The content of the acrylic emulsion polymer (A) in the aqueous dispersion pressure-sensitive adhesive composition of the present invention is not particularly limited, but since this is an essential component, the content is preferably 90 wt % or more and more preferably 95 wt % or more, based on the total weight (100 wt %) of the aqueous dispersion pressure-sensitive adhesive composition of the present invention.

The compound (B) contained as an essential component in the aqueous dispersion pressure-sensitive adhesive composition of the present invention plays a role as a crosslinking component. The compound (B) is a compound having, in the molecule, at least one nitrogen atom and two or more substituents represented by the following formula (1) bonded to the nitrogen atom, and having a solubility in water (25° C.) of 1 g/100 g or more. As for the compound (B), one compound may be used alone, or two or more compounds may be used in combination.

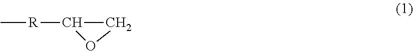

(wherein R represents a divalent group selected from the group consisting of a linear or branched alkylene group having a carbon number of 1 to 10, a phenylene group, an alkyl group-substituted phenylene group, a halogen-substituted phenylene group, and a heteroatom-containing alkylene group).

The heteroatom contained in the heteroatom-containing alkylene group is not particularly limited but is preferably nitrogen or oxygen.

In view of reactivity of the compound (B), R in formula (1) in the compound (B) is preferably a divalent group selected from the group consisting of a linear or branched alkylene group having a carbon number of 1 to 5, a phenylene group, an alkyl group-substituted phenylene group, a halogen-substituted phenylene group, and a heteroatom-containing alkylene group; more preferably a divalent group selected from the group consisting of a linear or branched alkylene group having a carbon number of 1 to 5 and a heteroatom-containing alkylene group having a carbon number of 1 to 5; and still more preferably one divalent group selected from a linear or branched alkylene group having a carbon number of 1 to 5.

The preferred substituent represented by formula (1) in the compound (B) includes glycidyl where R is a methylene group. When the substituent represented by formula (1) in the compound (B) is a glycidyl group, reactivity of the compound (B) particularly becomes high.

In the compound (B), all substituents represented by formula (1) may have the same structure or a part of the substituents represented by formula (1) or all substituents represented by formula (1) may have different structures, but it is preferred that all substituents represented by formula (1) have the same structure. Also, in the compound (B), when two or more substituents represented by formula (1) are bonded to one nitrogen atom, the substituents represented by formula (1) bonded to the same nitrogen atom preferably have the same structure.

The number of “nitrogen atoms to which the substituent represented by formula (1) is bonded” contained in the compound (B) is not particularly limited but, in view of reactivity or water solubility of the compound (B), the number is preferably from 1 to 5, more preferably from 1 to 3, and still more preferably 1.

In the compound (B), the nitrogen atom to which the substituent represented by formula (1) is bonded may be substituted by a functional group, other than the substituent represented by formula (1), such as carbonyl group, methylene group, ether group and (tertiary) amino group. Above all, in view of solubility in water and reactivity, the functional group is preferably a carbonyl group or a (tertiary) amino group.

Also, the compound (B) is a compound having at least two or more epoxy groups per molecule. The number of epoxy groups per molecule of the compound (B) is not particularly limited but is preferably from 2 to 10, more preferably from 3 to 5, and still more preferably 3. That is, the number of substituents represented by formula (1) in the compound (B) is preferably from 2 to 10, more preferably from 3 to 5, and still more preferably 3. As the number of epoxy groups per molecule of the compound (B) becomes larger, the crosslinking of the pressure-sensitive adhesive composition becomes denser (that is, the crosslinked structure of the polymer forming the pressure-sensitive adhesive layer becomes denser), and this makes it possible to prevent a wetting spread of the pressure-sensitive adhesive layer after formation of the pressure-sensitive adhesive layer or an increase in adhesive force due to a functional group (for example, a carboxyl group in the case where the above-described carboxyl group-containing unsaturated monomer is used as a raw material monomer of the acrylic emulsion polymer (A)) in the pressure-sensitive adhesive layer. If the number of epoxy groups per molecule of the compound (B) is excessively large, for example, exceeds 10, a gelled product (gel material) may be produced in the formed pressure-sensitive adhesive layer to impair appearance characteristics. Also, since the distance of epoxy groups from each other is reduced, an unreacted epoxy group may remain to cause an increase in adhesive force with aging in some cases.

Furthermore, the compound (B) is a water-soluble compound. The term “water-soluble” as used herein indicates that the solubility in 100 g of water at 25° C. (parts by weight of the compound capable of being dissolved per 100 parts by weight of water) is 1 g or more (1 g/100 g or more), preferably 10 g or more (10 g/100 g or more), and more preferably 30 g or more (30 g/100 g or more). The solubility of the compound (B) in water can be measured, for example, as follows.

### (Measuring Method of Solubility in Water)

Water (25° C.) and a compound (B), having the same weight, are mixed by using a stirrer under the conditions of a rotation speed of 300 rpm and 10 minutes, and the mixture is separated into an aqueous phase and an oil phase by centrifugation. The aqueous phase is then collected and dried at 120° C. for 1 hour, and the nonvolatile content (parts by weight of the nonvolatile component per 100 parts by weight of water) in the aqueous phase is determined from the weight loss on drying.

When the reactivity of the compound (B) is high, this is advantageous in that adhesive force to an adherend can be prevented from increasing with aging due to a functional group (particularly a carboxyl group in the above-described carboxyl group-containing unsaturated monomer used as a raw material monomer of the acrylic emulsion polymer (A)) in the pressure-sensitive adhesive layer. Furthermore, when the reactivity of the compound (B) is high, even if the amount of the compound (B) incorporated is reduced, good appearance characteristics and good pressure-sensitive adhesive characteristics can be achieved by adjusting the solvent insoluble content in the formed pressure-sensitive adhesive layer. In addition, when the reactivity of the compound (B) is high, the amount of the compound (B) incorporated can be reduced and therefore, there can be advantageously avoided a problem which is liable to occur in the case of incorporating a large amount of a crosslinking component, more specifically, a problem that the formed pressure-sensitive adhesive layer is changed in its pressure-sensitive adhesive characteristics with aging and cannot maintain pressure-sensitive adhesive characteristics for a long period of time.

The solubility of the compound (B) in water is high and therefore, the compound (B) can be easily blended at the production of the aqueous dispersion pressure-sensitive adhesive composition. Also, owing to the compound (B) having high solubility in water, it is easy to obtain a water-diluted solution with a high concentration. This water-diluted solution makes it possible to prevent viscosity reduction associated with the blending of the compound (B) at the production of the aqueous dispersion pressure-sensitive adhesive composition. In turn, the aqueous dispersion pressure-sensitive adhesive composition of the present invention is reduced in repelling by coated part during coating and is readily wetting to the coated part, as a result, coating appearance is improved (appearance failure during coating is suppressed). Furthermore, owing to the compound (B) having high solubility in water, a water-diluted solution with a high concentration can be easily obtained, so that an aqueous dispersion pressure-sensitive adhesive composition containing substantially no organic solvent can be obtained. In addition, since the compound (B) has high solubility in water, even when a water-diluted solution with a high concentration is produced, an aggregate due to dispersion failure is not produced. Therefore, the pressure-sensitive adhesive layer formed of the aqueous dispersion pressure-sensitive adhesive composition of the present invention is excellent in appearance characteristics.

The compound (B) preferably has, in view of its reactivity, a structure having two or more substituents represented by formula (1) where R is an alkylene group having a carbon number of 1, being bonded to one nitrogen atom in the molecule, that is, a structure having two or more glycidyl groups being bonded to one nitrogen atom in the molecule. The compound (B) more preferably has a structure having three substituents represented by formula (1) where R is an alkylene group having a carbon number of 1, being bonded to one nitrogen atom in the molecule, that is, a structure having three glycidyl groups being bonded to one nitrogen atom in the molecule.

Also, in view of solubility in water and reactivity, the compound (B) preferably has a structure having a glycidyl group and a carbonyl group being bonded to one nitrogen atom, or a structure having a glycidyl group and a methylene group being bonded to one nitrogen atom.

Specifically, the compound (B) is preferably N,N-bis(2,3-epoxypropyl)amine (another name: diglycidylamine), N,N,N-tri(2,3-epoxypropyl)amine (another name: triglycidylamine), polyglycidylamine, or anaxirone, more preferably N,N,N-tri(2,3-epoxypropyl)amine or anaxirone. Incidentally, N,N,N-tri(2,3-epoxypropyl)amine is a compound represented by the following formula (2), and anaxirone is a compound represented by the following formula (3).

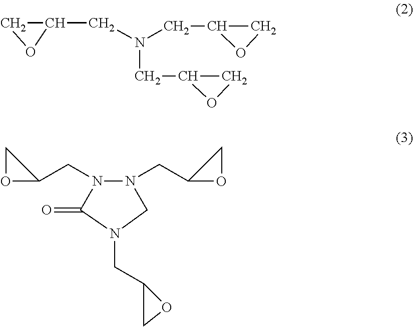

The content of the compound (B) in the aqueous dispersion pressure-sensitive adhesive composition of the present invention is not particularly limited but is preferably from 0.01 to 10 parts by weight, and more preferably from 0.05 to 3 parts by weight, per 100 parts by weight of the acrylic emulsion polymer (A). If the content is less than 0.01 parts by weight, the pressure-sensitive adhesive layer formed of the pressure-sensitive adhesive composition may lack cohesive force and cause a cohesion failure in the pressure-sensitive adhesive layer in some cases, whereas if the content exceeds 10 parts by weight, the pressure-sensitive adhesive layer formed of the pressure-sensitive adhesive composition may become excessively hard to bring about reduction in pressure-sensitive adhesive characteristics in some cases.

The molar ratio (ratio of the number of moles) of epoxy group of the compound (B) per mol of the functional group capable of reacting with the epoxy group of the compound (B) in the acrylic emulsion polymer (A) is not particularly limited but is preferably from 0.003 to 3.10, and more preferably from 0.015 to 0.922. If the molar ratio of epoxy group of the compound (B) is less than 0.003, the pressure-sensitive adhesive layer formed of the pressure-sensitive adhesive composition may lack cohesive force and cause a cohesive failure in the pressure-sensitive adhesive layer in some cases, whereas if the molar ratio of epoxy group of the compound (B) exceeds 3.10, the pressure-sensitive adhesive layer formed of the pressure-sensitive adhesive composition may become excessively hard to bring about significant reduction in pressure-sensitive adhesive characteristics in some cases.

Incidentally, the number of moles of epoxy group of the compound (B), in the case of adding 4 g of the compound (B) having an epoxy equivalent of 100 (g/eq) for example, can be calculated, for example, as follows.

The number of moles of epoxy group of the compound (B)=[content (amount added) of the compound (B)]/[epoxy equivalent]=4/100

The monomer components (raw material monomers) constituting the acrylic emulsion polymer (A) preferably contain a copolymerizable monomer providing a functional group (for example, a carboxyl group, an amino group or a hydroxyl group, particularly a carboxyl group) capable of reacting with epoxy group of the compound (B), together with the (meth)acrylic acid alkyl ester so that the acrylic emulsion polymer (A) can have a functional group capable of reacting with the epoxy group of compound (B). When the acrylic emulsion polymer (A) has a functional group capable of reacting with the epoxy group of compound (B), the functional group works out to a reaction point with the compound (B) during the stage of forming a pressure-sensitive adhesive layer and therefore, cohesive force of emulsion particles can be enhanced.

Examples of the copolymerizable monomer providing a functional group capable of reacting with epoxy group of the compound (B) include a carboxyl group-containing unsaturated monomer, an amino group-containing unsaturated monomer, and a hydroxyl group-containing unsaturated monomer, and among these, a carboxyl group-containing unsaturated monomer is preferred.

The aqueous dispersion pressure-sensitive adhesive composition of the present invention may contain various additives as long as the effects of the present invention are not impaired. Examples of various additives include a pigment, a filler, a leveling agent, a dispersant, a plasticizer, a stabilizer, an antioxidant, an ultraviolet absorber, an ultraviolet stabilizer, an antiaging agent, and an antiseptic. One of the additives may be used alone, or two or more thereof may be used in combination.

The additive also includes a tackifying component (tackifier). Examples of the tackifying component includes a rosin-based resin, a terpene-based resin, an aliphatic petroleum resin, an aromatic petroleum resin, a copolymer-based petroleum resin, an alicyclic petroleum resin, a xylene-based resin, and an elastomer. One of the tackifying components may be used alone, or two or more thereof may be used in combination.

The aqueous dispersion pressure-sensitive adhesive composition of the present invention is produced by mixing the above-described acrylic emulsion polymer (A) and the above-described compound (B). Additionally, as necessary, various additives may be blended. The mixing method is not particularly limited and a conventionally known or commonly employed mixing method for an emulsion is used, and, for example, stirring with a stirrer is preferred. The stirring conditions are not particularly limited, but, for example, the temperature is preferably from 10 to 50° C. and more preferably from 20 to 35° C., the stirring time is preferably from 5 to 30 minutes and more preferably from 10 to 20 minutes, and the rotation speed in the stirring is preferably from 10 to 2,000 rpm and more preferably from 30 to 1,000 rpm.

At the time of mixing the acrylic emulsion polymer (A) and the compound (B) in the production of the aqueous dispersion pressure-sensitive adhesive composition of the present invention, the compound (B) is preferably added (blended) in the form of an aqueous solution from the standpoint of environment as well as viscosity of the aqueous dispersion pressure-sensitive adhesive composition and also in view of residual organic solvent.

The concentration of the compound (B) in the aqueous solution of the compound (B) is not particularly limited but is preferably from 1 to 80 wt %, more preferably from 5 to 60 wt %, and still more preferably from 10 to 50 wt %. If the concentration is less than 1 wt %, viscosity of the aqueous dispersion pressure-sensitive adhesive composition in which the compound (B) is mixed in the form of an aqueous solution of the compound (B) may be reduced to impair the coating appearance in some cases, whereas if the concentration exceeds 80 wt %, the viscosity of the aqueous solution of the compound (B) may become excessively high, making it difficult to mix the acrylic emulsion polymer (A) and the compound (B) in some cases.

### (Pressure-Sensitive Adhesive Sheet)

The pressure-sensitive adhesive sheet of the present invention has at least a pressure-sensitive adhesive layer formed of the aqueous dispersion pressure-sensitive adhesive composition of the present invention. Incidentally, in the pressure-sensitive adhesive sheet of the present invention, the “pressure-sensitive adhesive sheet” includes a tape form, that is, a “pressure-sensitive adhesive tape”. Also, the “pressure-sensitive adhesive layer formed of the aqueous dispersion pressure-sensitive adhesive composition of the present invention” is sometimes referred to as the “pressure-sensitive adhesive layer of the present invention”.

The pressure-sensitive adhesive sheet of the present invention may be a pressure-sensitive adhesive sheet of a so-called “substrate-less type” having no substrate (substrate layer) (hereinafter, sometimes referred to as a “substrate-less pressure-sensitive adhesive sheet”) or may be a pressure-sensitive adhesive sheet of a type having a substrate (hereinafter, sometimes referred to as a “substrate-attached pressure-sensitive adhesive sheet”). In the case where the pressure-sensitive adhesive sheet of the present invention is a substrate-less type, specific examples of its configuration include a double-coated pressure-sensitive adhesive sheet consisting of only the pressure-sensitive adhesive layer of the present invention, and a double-coated pressure-sensitive adhesive sheet comprising the pressure-sensitive adhesive layer of the present invention and a pressure-sensitive adhesive layer other than the pressure-sensitive adhesive layer of the present invention (hereinafter, sometimes referred to as “another pressure-sensitive adhesive layer”). Also, in the case where the pressure-sensitive adhesive sheet of the present invention is a substrate-attached type, specific examples of its configuration include a single-coated pressure-sensitive adhesive sheet having the pressure-sensitive adhesive layer of the present invention on one side of a substrate, a double-coated pressure-sensitive adhesive sheet having the pressure-sensitive adhesive layer of the present invention on both sides of a substrate, and a double-coated pressure-sensitive adhesive sheet having the pressure-sensitive adhesive layer of the present invention on one side of a substrate and having another pressure-sensitive adhesive layer on the other side of the substrate.

In the pressure-sensitive adhesive sheet of the present invention, the solvent insoluble content (the ratio of the solvent insoluble component; sometimes referred to as a “gel fraction”) of the pressure-sensitive adhesive layer of the present invention is not particularly limited but is preferably 20 wt % or more, more preferably 25 wt % or more, and still more preferably 30 wt % or more. The upper limit of the solvent insoluble content is not particularly limited but is, for example, 90 wt %. If the solvent insoluble content is less than 20 wt %, in the pressure-sensitive adhesive layer, sufficient pressure-sensitive adhesive characteristics may not be obtained or as a result of containing a large amount of low molecular weight components, the pressure-sensitive adhesive layer may lack cohesive force and cause contamination on an adherend in some cases. Also, pressure-sensitive adhesive characteristics may not be maintained for a long period of time in some cases.

The solvent insoluble content of the pressure-sensitive adhesive layer of the present invention is a value calculated according to the following “measuring method of solvent insoluble content”.

### (Measuring Method of Solvent Insoluble Content)

About 0.1 g of the pressure-sensitive adhesive layer is sampled, wrapped in a porous tetrafluoroethylene sheet having an average pore size of 0.2 μm (trade name, “NTF1122”, produced by Nitto Denko Corporation) and then tied with a kite string, and the weight here is measured. This weight is taken as weight before immersion. The weight before immersion is the total weight of the pressure-sensitive adhesive layer (sampled above), the tetrafluoroethylene sheet and the kite string. Also, the total weight of the tetrafluoroethylene sheet and the kite string is measured and taken as tare weight.

Next, the article (referred to as “sample”) obtained by wrapping the pressure-sensitive adhesive layer in a tetrafluoroethylene sheet and tying it with a kite string is placed in a 50 -ml vessel filled with ethyl acetate and allowed to stand at 23° C. for 7 days. Thereafter, the sample (after treatment with ethyl acetate) is taken out of the vessel, transferred into an aluminum-made cup, dried in a drier at 130° C. for 2 hours to remove ethyl acetate, and measured for the weight. This weight is taken as weight after immersion.

The solvent insoluble content is calculated according to the following formula:

Solvent insoluble content (wt %)=(a−b)/(c−b)×100

(wherein a is the weight after immersion, b is the tare weight, and c is the weight before immersion).

The glass transition temperature of the acrylic polymer (after crosslinking) forming the pressure-sensitive adhesive layer of the present invention is not particularly limited, but is preferably from −70 to −10° C., and more preferably from −55 to −20° C. If the glass transition temperature exceeds −10° C., the pressure-sensitive adhesive layer may lack adhesive force and cause lifting or separation from an adherend during processing or the like in some cases, whereas if it is less than −70° C., heavy peeling may occur in higher peeling speed (tensile speed) region to reduce working efficiency. The glass transition temperature of the polymer component constituting the pressure-sensitive adhesive layer of the present invention may be also adjusted, for example, by the formulation of the raw material monomers (raw material monomer components) of the acrylic emulsion polymer (A).

The pressure-sensitive adhesive layer of the present invention in the pressure-sensitive adhesive sheet of the present invention may have either a single-layer configuration or a laminate configuration. The thickness of the pressure-sensitive adhesive layer is not particularly limited but is preferably from 5 to 1,000 μm and more preferably from 10 to 200 μm. In the case where the pressure-sensitive adhesive sheet of the present invention is a substrate-attached double-coated pressure-sensitive adhesive sheet having the pressure-sensitive adhesive layer of the present invention on both sides of a substrate, the pressure-sensitive adhesive layers may have the same thickness or may be different in the thickness. Incidentally, in the case of a substrate-attached double-coated pressure-sensitive adhesive sheet, the thickness in the range above of the pressure-sensitive adhesive layer is the thickness of the pressure-sensitive adhesive layer on one side.

The pressure-sensitive adhesive sheet of the present invention may have other layers (for example, an intermediate layer and an undercoat layer) as long as the effects of the present invention are not impaired.

The substrate is not particularly limited, but examples thereof include a plastic film formed of a plastic such as polyolefin resin (e.g., polyethylene and polypropylene), polyester resin (e.g., polyethylene terephthalate (PET)), vinyl chloride resin, vinyl acetate resin, polyimide resin, fluororesin, and cellophane; a paper such as kraft paper and Japanese paper; a fabric such as woven fabric or nonwoven fabric of single yarns, mixed yarns or the like formed of a fibrous substance (e.g., natural fiber, semisynthetic fiber, synthetic fiber) such as Manila hemp, pulp, rayon, acetate fiber, polyester fiber, polyvinyl alcohol fiber, polyamide fiber, and polyolefin fiber; a rubber sheet formed of natural rubber, butyl rubber or the like; a foam sheet made from a foam formed of polyurethane, polychloroprene rubber or the like; a metal foil such as aluminum foil and copper foil; and a composite thereof. Above all, the substrate is preferably a polyolefin resin-made film such as polypropylene-made film or polyethylene-made film, or a polyester resin-made film such as polyethylene terephthalate-made film. The substrate may be any of transparent, semi-transparent and opaque. Also, the surface of the substrate may be subjected to an appropriate conventionally known or commonly employed surface treatment, for example, a physical treatment such as corona discharge treatment and plasma treatment, or a chemical treatment such as undercoating treatment and back surface treatment.

The thickness of the substrate is not particularly limited and may be appropriately selected as long as the handleability and the like are not impaired. For example, the thickness is preferably from 10 to 1,000 μm and more preferably from 20 to 500 μm.

In the pressure-sensitive adhesive sheet of the present invention, a release liner (separator) may be stacked on the pressure-sensitive adhesive layer for the purpose of protecting the pressure-sensitive adhesive layer. The release liner is not particularly limited and includes a known release liner. A release liner in which a release layer is formed on at least one surface of a release liner substrate is preferred.

The release liner substrate is not particularly limited, and examples thereof include a plastic film, a paper, a foam, and a metal foil. Above all, the release liner substrate is preferably a plastic film. The thickness of the release liner substrate is not particularly limited and may be appropriately selected according to the purpose. Examples of the material of the plastic film as the release liner substrate include polyester such as polyethylene terephthalate, polyolefin such as polypropylene and ethylene-propylene copolymer, and thermoplastic resin such as polyvinyl chloride. The plastic film may be either an unstretched film or a stretched (uniaxially stretched or biaxially stretched) film.

The release layer formed on the release liner substrate is not particularly limited, and examples thereof include a release layer formed of a silicone-based release agent, a release layer formed of a fluorine-based release agent, and a release layer formed of a long-chain alkyl-based release agent. The release layer may be formed on only one surface of the release liner substrate or may be formed on both surfaces of the release liner substrate.

The pressure-sensitive adhesive sheet of the present invention is produced by forming a pressure-sensitive adhesive layer from the above-described aqueous dispersion pressure-sensitive adhesive composition on a support such as a substrate described above (the substrate used for the substrate-attached pressure-sensitive adhesive sheet) or a release liner.

Formation of the pressure-sensitive adhesive layer of the present invention from the aqueous dispersion pressure-sensitive adhesive composition is performed by coating the aqueous dispersion pressure-sensitive adhesive composition on a substrate to form a coated layer, and drying and heating the coated layer. Crosslinking by the compound (B) is effected during the drying and heating. For example, crosslinking is effected by heating the pressure-sensitive adhesive sheet after dewatering and drying in the drying step. Incidentally, at the time of coating the aqueous dispersion pressure-sensitive adhesive composition on a release liner, the release liner surface to be coated with the aqueous dispersion pressure-sensitive adhesive composition is the surface on which the release layer is provided.

At the time of coating the aqueous dispersion pressure-sensitive adhesive composition, a commonly employed coater may be used. Examples of the coater include a gravure roll coater, a reverse roll coater, a kiss roll coater, a dip roll coater, a bar coater, a knife coater, and a spray coater.

For example, in the case where the pressure-sensitive adhesive sheet of the present invention is a substrate-attached pressure-sensitive adhesive sheet, the substrate-attached pressure-sensitive adhesive sheet is produced, for example, by a method of coating the aqueous dispersion pressure-sensitive adhesive composition directly on at least one surface (one surface or both surfaces) of a substrate so as to have a predetermined thickness after drying, or a method of coating the aqueous dispersion pressure-sensitive adhesive composition on a release liner so as to have a predetermined thickness after drying, thereby forming a pressure-sensitive adhesive layer, and then transferring the pressure-sensitive adhesive layer on a substrate. Furthermore, in the case where a release treated layer (peel treated layer) is formed on the back surface of the substrate, the substrate-attached pressure-sensitive adhesive sheet may be produced as a roll-wound pressure-sensitive adhesive tape by winding the sheet into a roll while superposing the pressure-sensitive adhesive layer formed on one surface of the substrate and the release treated layer on the back surface of the substrate

The pressure-sensitive adhesive sheet of the present invention has at least a pressure-sensitive adhesive layer formed of the aqueous dispersion pressure-sensitive adhesive composition and therefore, the pressure-sensitive adhesive sheet contains substantially no organic solvent, has excellent appearance characteristics and furthermore, maintains pressure-sensitive adhesive characteristics for a long period of time.

The pressure-sensitive adhesive sheet of the present invention is excellent in adhesive force to various adherends and is used as a general-purpose pressure-sensitive adhesive sheet. The pressure-sensitive adhesive sheet of the present invention is applied, for example, to an adherend such as plastic (e.g., acrylic resin, polycarbonate resin, polyethylene terephthalate (PET) resin) or glass.

### EXAMPLES

The present invention is described in greater detail below by referring to Examples, but the present invention is not limited to these Examples.

### Example 1

### Preparation of Aqueous Dispersion Acrylic Pressure-Sensitive Adhesive Composition

A monomer emulsion was prepared by emulsifying and dispersing 96.2 parts by weight of butyl acrylate, 3.8 parts by weight of acrylic acid, 7.7 parts by weight of an ether sulfate-type nonreactive anionic surfactant (trade name, “LATEMUL E118-B”, produced by Kao Corporation, active ingredient: 26 wt %), 0.05 parts by weight of t-dodecanethiol (produced by Wako Pure Chemical Industries, Ltd.), and 24.9 parts by weight of water, by means of an emulsifying machine.

Into a reaction vessel equipped with a condenser, a nitrogen inlet tube, a thermometer and a stirring device, 45.0 parts by weight of water and 0.10 parts by weight of a water-soluble azo-based polymerization initiator (trade name, “VA-057”, produced by Wako Pure Chemical Industries, Ltd.) were weighed, and the monomer emulsion obtained above was added dropwise over 4 hours under nitrogen purging. The inner bath temperature was kept at 60±1° C. during the polymerization. After 4 hours following the initiation of polymerization, ripening was effected by further continuing the reaction for 3 hours while keeping the inner bath temperature at 60±1° C. Thereafter, the reaction product was neutralized with aqueous ammonia in a concentration of 10 wt % to prepare a liquid dispersion of an acrylic emulsion polymer.

Subsequently, to the liquid dispersion obtained above, 0.06 parts by weight of N,N,N-tri(2,3-epoxypropyl)amine (water-soluble crosslinking agent, polyfunctional epoxy-based crosslinking agent, number of functional groups: about 3, solubility in water (25° C.): 100 g/100 g) was added per 100 parts by weight of the acrylic emulsion polymer to prepare an aqueous dispersion acrylic pressure-sensitive adhesive composition.

Incidentally, at the time of adding N,N,N-tri(2,3-epoxypropyl)amine to the liquid dispersion, its water-diluted solution having a concentration of 50 wt % was used.

### (Formation of Pressure-Sensitive Adhesive Layer and Production of Pressure-Sensitive Adhesive Sheet)

Furthermore, the aqueous dispersion acrylic pressure-sensitive adhesive composition obtained above was applied (coated) on a PET film (trade name, “LUMIRROR S10-25”, produced by Toray Industries, Inc., thickness: 25 μm) by using an applicator manufactured by Tester Sangyo Co,. Ltd. so as to be a thickness after drying of 60 μm, and the coating was dried at 120° C. for 2 minutes in a circulating hot air oven and then aged at 50° C. for 3 days to obtain a pressure-sensitive adhesive sheet.

### Example 2

An aqueous dispersion acrylic pressure-sensitive adhesive composition was prepared in the same manner as in Example 1 except for adding 0.1 parts by weight of N,N,N-tri(2,3-epoxypropyl)amine.

Incidentally, at the time of adding N,N,N-tri(2,3-epoxypropyl)amine to the liquid dispersion, its water-diluted solution having a concentration of 50 wt % was used.

Using the aqueous dispersion acrylic pressure-sensitive adhesive composition above, a pressure-sensitive adhesive sheet was obtained in the same manner as in Example 1.

### Example 3

### Preparation of Aqueous Dispersion Acrylic Pressure-Sensitive Adhesive Composition

A monomer emulsion was prepared by emulsifying and dispersing 95.4 parts by weight of butyl acrylate, 4.6 parts by weight of methacrylic acid, 7.7 parts by weight of an ether sulfate-type nonreactive anionic surfactant (trade name, “LATEMUL E118-B”, produced by Kao Corporation, active ingredient: 26 wt %), 0.05 parts by weight of t-dodecanethiol (produced by Wako Pure Chemical Industries, Ltd.) and 24.9 parts by weight of water, by means of an emulsifying machine.

Into a reaction vessel equipped with a condenser, a nitrogen inlet tube, a thermometer and a stirring device, 45.0 parts by weight of water and 0.10 parts by weight of a water-soluble azo-based polymerization initiator (trade name, “VA-057”, produced by Wako Pure Chemical Industries, Ltd.) were weighed, and the monomer emulsion obtained above was added dropwise over 4 hours under nitrogen purging. The inner bath temperature was kept at 60±1° C. during the polymerization. After 4 hours following the initiation of polymerization, ripening was effected by further continuing the reaction for 3 hours while keeping the inner bath temperature at 60±1° C. Thereafter, the reaction product was neutralized with aqueous ammonia in a concentration of 10 wt % to prepare a liquid dispersion of an acrylic emulsion polymer.

Subsequently, to the liquid dispersion obtained above, 0.05 parts by weight of N,N,N-tri(2,3-epoxypropyl)amine was added per 100 parts by weight of the acrylic emulsion polymer to prepare an aqueous dispersion acrylic pressure-sensitive adhesive composition.

Incidentally, at the time of adding N,N,N-tri(2,3-epoxypropyl)amine to the liquid dispersion, its water-diluted solution having a concentration of 50 wt % was used.

### (Formation of Pressure-Sensitive Adhesive Layer and Production of Pressure-Sensitive Adhesive Sheet)

Subsequently, using the aqueous dispersion acrylic pressure-sensitive adhesive composition above, a pressure-sensitive adhesive sheet was obtained in the same manner as in Example 1.

### Comparative Example 1

### Preparation of Aqueous Dispersion Acrylic Pressure-Sensitive Adhesive Composition

An aqueous dispersion acrylic pressure-sensitive adhesive composition was prepared in the same manner as in Example 1 except for using trade name, “DENACOL EX-614B” (water-soluble crosslinking agent, sorbitol polyglycidyl ether, produced by Nagase ChemteX Corporation, epoxy equivalent: 191, number of functional groups: about 4, solubility in water (25° C.): 10 g/100 g), in place of N,N,N-tri(2,3-epoxypropyl)amine.

Incidentally, at the time of adding, trade name, “DENACOL EX-614B” to the liquid dispersion, its water-diluted solution having a concentration of 1 wt % was used.

### (Formation of Pressure-Sensitive Adhesive Layer and Production of Pressure-Sensitive Adhesive Sheet)

Furthermore, the aqueous dispersion acrylic pressure-sensitive adhesive composition obtained above was applied (coated) on a PET film (trade name, “LUMIRROR S10-25”, produced by Toray Industries, Inc., thickness: 25 μm) by using an applicator manufactured by Tester Sangyo Co,. Ltd. so as to be a thickness after drying of 60 μm, and the coating was dried at 120° C. for 2 minutes in a circulating hot air oven and then aged at 50° C. for 3 days to obtain a pressure-sensitive adhesive sheet.

### Comparative Example 2

### Preparation of Aqueous Dispersion Acrylic Pressure-Sensitive Adhesive Composition

An aqueous dispersion acrylic pressure-sensitive adhesive composition was prepared in the same mariner as in Example 1 except for using 0.6 parts by weight of trade name, “DENACOL EX-614B” (water-soluble crosslinking agent, sorbitol polyglycidyl ether, produced by Nagase ChemteX Corporation, epoxy equivalent: 191, number of functional groups: about 4, solubility in water (25° C.): 10 g/100 g), in place of 0.06 parts by weight of N,N,N-tri(2,3-epoxypropyl)amine.

Incidentally, at the time of adding, trade name, “DENACOL EX-614B” to the liquid dispersion, its water-diluted solution having a concentration of 1 wt % was used.

### (Formation of Pressure-Sensitive Adhesive Layer and Production of Pressure-Sensitive Adhesive Sheet)

Furthermore, the aqueous dispersion acrylic pressure-sensitive adhesive composition obtained above was applied (coated) on a PET film (trade name, “LUMIRROR S10-25”, produced by Toray Industries, Inc., thickness: 25 μm) by using an applicator manufactured by Tester Sangyo Co,. Ltd. so as to be a thickness after drying of 60 μm, and the coating was dried at 120° C. for 2 minutes in a circulating hot air oven and then aged at 50° C. for 3 days to obtain a pressure-sensitive adhesive sheet.

### Comparative Example 3

An aqueous dispersion acrylic pressure-sensitive adhesive composition was prepared in the same manner as in Example 1 except for using 0.1 parts by weight of, trade name, “TETRAD-C” (oil-soluble crosslinking agent, 1,3-bis(N,N-diglycidylaminoethyl)cyclohexane, epoxy equivalent: 110, insoluble in water, number of functional groups: about 4), in place of 0.06 parts by weight of N,N,N-tri(2,3-epoxypropyl)amine.

Incidentally, at the time of adding, trade name, “TETRAD-C” to the liquid dispersion, its diluted solution diluted with ethyl acetate so as to have a concentration of 50 wt % was used.

Using the aqueous dispersion acrylic pressure-sensitive adhesive composition above, a pressure-sensitive adhesive sheet was obtained in the same manner as in Example 1.

### Comparative Example 4

An aqueous dispersion acrylic pressure-sensitive adhesive composition was prepared in the same manner as in Example 3 except for using, trade name, “TETRAD-C” (oil-soluble crosslinking agent, 1,3-bis(N,N-diglycidylaminoethyl)cyclohexane, epoxy equivalent: 110, insoluble in water, number of functional groups: about 4), in place of N,N,N-tri(2,3-epoxypropyl)amine.

Incidentally, at the time of adding, trade name, “TETRAD-C” to the liquid dispersion, its diluted solution diluted with ethyl acetate so as to have a concentration of 50 wt % was used.

Using the aqueous dispersion acrylic pressure-sensitive adhesive composition above, a pressure-sensitive adhesive sheet was obtained in the same manner as in Example 3.

### Comparative Example 5

An aqueous dispersion acrylic pressure-sensitive adhesive composition was prepared in the same manner as in Example 1 except for using 0.6 parts by weight of, trade name, “TEPIC-G” (water-soluble crosslinking agent, tris(2,3-epoxypropyl)isocyanurate, epoxy equivalent: 110, number of functional groups: about 3, solubility in water (25° C.): 0.9 g/100 g), in place of 0.06 parts by weight of N,N,N-tri(2,3-epoxypropyl)amine.

Incidentally, at the time of adding, trade name, “TEPIC-G” to the liquid dispersion, its water-diluted solution having a concentration of 2 wt % was used. Using the aqueous dispersion acrylic pressure-sensitive adhesive composition above, a pressure-sensitive adhesive sheet was obtained in the same manner as in Example 1.

### Comparative Example 6

An aqueous dispersion acrylic pressure-sensitive adhesive composition was prepared in the same manner as in Example 1 except for using 0.05 parts by weight of, trade name, “TETRAD-C” (oil-soluble crosslinking agent, 1,3-bis(N,N-diglycidylaminoethyl)cyclohexane, epoxy equivalent: 110, insoluble in water, number of functional groups: about 4), in place of 0.06 parts by weight of N,N,N-tri(2,3-epoxypropyl)amine.

Incidentally, at the time of adding, trade name, “TETRAD-C” to the liquid dispersion, it was added directly without dilution (concentration: 100 wt %).

Using the aqueous dispersion acrylic pressure-sensitive adhesive composition above, a pressure-sensitive adhesive sheet was obtained in the same manner as in Example 1.

### (Evaluation)

The aqueous dispersion acrylic pressure-sensitive adhesive compositions and pressure-sensitive adhesive sheets obtained in Examples and Comparative Examples were evaluated by the following measuring methods or evaluation methods. The evaluation results are shown in Table 1.

(1) Adhesive Force (Against SUS Plate, 180° Peel, Tensile Speed of 300 mm/min)

The pressure-sensitive adhesive sheet (sample size: 20 mm (width)×100 mm (length)) was pressure-bonded to an SUS plate (SUS stainless steel plate) under the condition of one reciprocation of a 2-kg rubber roller to prepare a measurement sample. This measurement sample was allowed to stand in an environment of 23° C. and 50% RH for 30 minutes and then subjected to a 180° peel test under the condition of a tensile speed of 300 mm/min, and adhesive force (N/20 mm) of the pressure-sensitive adhesive sheet to the SUS plate was measured and taken as adhesive force.

### (2) Holding Power (Against Bakelite Plate, Holding Under Load of 500 g in Atmosphere at Temperature of 60° C. for 2 Hours)

The pressure-sensitive adhesive sheet of 10 mm in width was laminated to a bakelite plate (phenolic resin plate) in an environment at room temperature (23° C.) under the pressure-bonding conditions of a 2-kg roller and one reciprocation such that the contact area became 10 mm (width)×20 mm (length), to prepare a measurement sample. The measurement sample was allowed to stand at room temperature for 30 minutes from the preparation and further allowed to stand in an atmosphere at a temperature of 60° C. for 30 minutes.

Thereafter, the bakelite plate was hung down by arranging the length direction of the pressure-sensitive adhesive sheet in the vertical direction, and a load of 500 g was applied to the free end of the pressure-sensitive adhesive sheet so that the load was applied uniformly in the width direction of the pressure-sensitive adhesive sheet. The load was loaded in an atmosphere at a temperature of 60° C. for 2 hours.

After the passage of 2 hours, the distance (displaced distance) by which the pressure-sensitive adhesive sheet was displaced was measured and evaluated according to the following evaluation criteria.

### Evaluation Criteria:

Good (A): The displaced distance was within 0.3 mm.

Bad (B): The displaced distance exceeded 0.3 mm.

### (3) Inclusion of Organic Solvent

This was judged by whether an organic solvent was used at the production of the pressure-sensitive adhesive sheet or not. The case where, in the preparation of the aqueous dispersion acrylic pressure-sensitive adhesive composition used for the production of the pressure-sensitive adhesive sheet, at the time of adding a crosslinking agent (crosslinking component) to a liquid dispersion, the crosslinking agent could not be incorporated into the liquid dispersion without using a crosslinking agent solution diluted by an organic solvent and an organic solvent was inevitably blended in the pressure-sensitive adhesive sheet, was rated as “organic solvent was contained (contained)”. On the other hand, the case where, at the time of adding a crosslinking agent (crosslinking component) to a liquid dispersion, the crosslinking agent could be incorporated into the liquid dispersion even without diluting the crosslinking agent by an organic solvent and a pressure-sensitive adhesive sheet containing substantially no organic solvent could be obtained, was rated as “organic solvent was not contained (none)”.

### (4) Appearance (Presence or Absence of Dent or Gel Material)

The condition of the pressure-sensitive adhesive layer surface of the pressure-sensitive adhesive sheet was observed by visual inspection. The number of defects (dent and gel material (aggregate)) in the observation range of 10 cm (length)×10 cm (width) was measured, and the appearance was evaluated according to the following criteria.

Number of defects was 0 to 100: good appearance (A)

Number of defects was 101 or more: bad appearance (B)

### (5) Long-Term Storage Stability

The pressure-sensitive adhesive sheet was stored at room temperature for half a year from the preparation and then evaluated for its various characteristics (solvent insoluble content, adhesive force, holding power, tensile elastic modulus), and whether a change in the physical and pressure-sensitive adhesive characteristics occurred or not was confirmed. The case where the characteristics were not changed or little changed, the long-term storage stability was rated Good (A); and the case where the characteristics were greatly changed, rated Bad (B).

TABLE 1

| | | | Examples | | | Comparative Examples | | | | | |
|---|---|---|---|---|---|---|---|---|---|---|---|
| | | | 1 | 2 | 3 | 1 | 2 | 3 | 4 | 5 | 6 |
| Acrylic | Raw material | BA | 96.2 | 96.2 | 95.4 | 96.2 | 96.2 | 96.2 | 95.4 | 96.2 | 96.2 |
| emulsion | monomer | AA | 3.8 | 3.8 | — | 3.8 | 3.8 | 3.8 | — | 3.8 | 3.8 |
| polymer | [parts by weight] | | | | | | | | | | |
| | | MAA | — | — | 4.6 | — | — | — | 4.6 | — | — |
| | Polymerization | VA-057 | 0.10 | 0.10 | 0.10 | 0.10 | 0.10 | 0.10 | 0.10 | 0.10 | 0.10 |
| | Initiator | | | | | | | | | | |
| | [parts by weight] | | | | | | | | | | |
| | Chain transfer agent | t-LSH | 0.05 | 0.05 | 0.05 | 0.05 | 0.05 | 0.05 | 0.05 | 0.05 | 0.05 |
| | [parts by weight] | | | | | | | | | | |
| | Emulsifier | E118B | 7.7 | 7.7 | 7.7 | 7.7 | 7.7 | 7.7 | 7.7 | 7.7 | 7.7 |
| | [parts by weight] | | | | | | | | | | |
| Aqueous | Acrylic emulsion polymer [parts by weight] | | 100 | 100 | 100 | 100 | 100 | 100 | 100 | 100 | 100 |
| dispersion | Water-Soluble | N,N,N-tri(2,3- | 0.06 | 0.1 | 0.05 | — | — | — | — | — | — |
| acrylic | crosslinking | epoxypropyl)amine | | | | | | | | | |
| pressure- | agent [parts | DENACOL EX-614B | — | — | — | 0.06 | 0.6 | — | — | — | — |
| sensitive | by weight] | TEPIC-G | — | — | — | — | — | — | — | 0.6 | — |
| adhesive | Oil-soluble | TETRAD-C | — | — | — | — | — | 0.1 | 0.05 | — | 0.05 |
| composition | crosslinking agent | | | | | | | | | | |
| | [parts by weight] | | | | | | | | | | |

| | | | | | | | | | | |
|---|---|---|---|---|---|---|---|---|---|---|
| | Dilution concentration of crosslinking agent | 50 | 50 | 50 | 1 | 1 | 50 | 50 | 2 | 100 |
| | [wt %] | | | | | | | | | |
| Pressure- | Substrate | PET | PET | PET | PET | PET | PET | PET | PET | PET |
| sensitive | | Film | Film | Film | Film | Film | Film | Film | Film | Film |

| | | | | | | | | | | | |
|---|---|---|---|---|---|---|---|---|---|---|---|
| adhesive | Pressure-sensitive | Thickness [μm] | 60 | 60 | 60 | 60 | 60 | 60 | 60 | 60 | 60 |
| sheet | adhesive layer | Gel fraction [%] | 65.0 | 82.9 | 69.9 | 20.0 | 77.8 | 82.6 | 67.7 | 64.4 | 65.0 |

| | | | | | | | | | | |
|---|---|---|---|---|---|---|---|---|---|---|
| Evaluation | Adhesive force [N/20 mm] | 4.6 | 4.1 | 1.1 | 6.1 | 4 | 3.9 | 2 | 3.4 | 4 |
| results | Holding power (60° C., 500 g, 2 h) | A | A | A | B | A | A | A | A | A |
| | Inclusion of organic solvent | none | none | none | none | none | contained | contained | none | none |
| | Coating appearance | A | A | A | A | A | B | B | B | B |
| | Long-term storage stability | A | A | A | A | B | A | A | A | A |

Abbreviations used in Table 1 are as follows.
BA: Butyl acrylate
AA: Acrylic acid
MAA: Methacrylic acid
VA-057: Water-soluble azo-based polymerization initiator (trade name, “VA-057”, produced by Wako Pure Chemical Industries, Ltd.)
t-LSH: (t-Dodecanethiol, produced by Wako Pure Chemical Industries, Ltd.)
E118B: Ether sulfate-type nonreactive anionic surfactant (trade name, “LATEMUL E118-B”, produced by Kao Corporation)
DENACOL EX-614B: Trade name, “DENACOL EX-614B” (water-soluble crosslinking agent, sorbitol polyglycidyl ether, produced by Nagase ChemteX Corporation, epoxy equivalent: 191, number of functional groups: about 4, solubility in water (25° C.): 10 g/100 g)
TEPIC-G: Trade name, “TEPIC-G” (water-soluble crosslinking agent, tris(2,3-epoxypropyl)isocyanurate, epoxy equivalent: 110, number of functional groups: about 3, solubility in water (25° C.): 0.9 g/100 g)
TETRAD-C: Trade name, “TETRAD-C” (oil-soluble crosslinking agent, 1,3-bis(N,N-diglycidylaminoethyl)cyclohexane, epoxy equivalent: 110, insoluble in water, number of functional groups: about 4)

In Example 1, N,N,N-tri(2,3-epoxypropyl)amine having high solubility in water was used and therefore, the N,N,N-tri(2,3-epoxypropyl)amine concentration in the water-diluted solution added to the liquid dispersion could be more increased, as a result, reduction in viscosity of the aqueous dispersion acrylic pressure-sensitive adhesive composition as the coating solution could be suppressed. For this reason, in Example 1, the repelling of the aqueous dispersion acrylic pressure-sensitive adhesive composition during coating could be improved and good coating appearance was obtained. On the other hand, in Comparative Example 5, a compound (trade name, “TEPIC-G”) having low solubility in water despite containing three structures having a glycidyl group being bonded to a nitrogen atom was used in place of N,N,N-tri(2,3-epoxypropyl)amine and therefore, the concentration of the crosslinking agent in the water-diluted solution added to the liquid dispersion could not be increased, as a result, reduction in viscosity of the aqueous dispersion acrylic pressure-sensitive adhesive composition as the coating solution could not be suppressed. For this reason, in Comparative Example 5, repelling of the aqueous dispersion acrylic pressure-sensitive adhesive composition was generated during coating and a pressure-sensitive adhesive sheet excellent in coating appearance could not be obtained.

In Example 1, N,N,N-tri(2,3-epoxypropyl)amine having a structure having a glycidyl group being bonded to a nitrogen atom was used. Since the structure having a glycidyl group being bonded to a nitrogen atom in the N,N,N-tri(2,3-epoxypropyl)amine has high reactivity, the pressure-sensitive adhesive sheet of Example 1 had a solvent insoluble content (gel content) necessary to exert good tape characteristics (pressure-sensitive adhesive characteristics), despite the small content of N,N,N-tri(2,3-epoxypropyl)amine. On the other hand, in Comparative Examples 1 and 2, a compound (trade name “DENACOL EX-614B”) having a structure having a glycidyl group being bonded to an oxygen atom was used in place of N,N,N-tri(2,3-epoxypropyl)amine, and the reactivity of the structure having a glycidyl group being bonded to an oxygen atom is low compared with the reactivity of the structure having a glycidyl group being bonded to a nitrogen atom. For this reason, in Comparative Example 1, although the compound having a structure having a glycidyl group being bonded to an oxygen atom was used in the same amount as the amount of N,N,N-tri(2,3-epoxypropyl)amine used in Example 1, the pressure-sensitive adhesive sheet did not achieve a solvent insoluble content (gel content) necessary to exert good tape characteristics (pressure-sensitive adhesive characteristics). Also, in Comparative Example 2, the compound having a structure having a glycidyl group being bonded to an oxygen atom was used in a large amount and the pressure-sensitive adhesive sheet achieved a solvent insoluble content (gel content) necessary to exert good tape characteristics (pressure-sensitive adhesive characteristics), but since the compound having a structure having a glycidyl group being bonded to an oxygen atom was used in a large amount, the tape characteristics (pressure-sensitive adhesive characteristics) were changed with aging and the tape performance could not be maintained for a long period of time.

When Example 2 and Comparative Example 3 were compared, they were similar in the tape characteristics. Also, when Example 3 and Comparative Example 4 were compared, they were similar in the tape characteristics. However, in Examples 2 and 3, since N,N,N-tri(2,3-epoxypropyl)amine in the aqueous dispersion pressure-sensitive adhesive composition was water-soluble, a water-diluted solution was used at the preparation of the aqueous dispersion acrylic pressure-sensitive adhesive composition. Accordingly, in Examples 2 and 3, remaining of an organic solvent did not occur and substantially no organic solvent was contained in the pressure-sensitive adhesive sheet. On the other hand, in Comparative Examples 3 and 4, since, trade mark, “TETRAD-C” was oil-soluble, a solution diluted with an organic solvent was used at the preparation of the aqueous dispersion acrylic pressure-sensitive adhesive composition. For this reason, in Comparative Examples 3 and 4, the pressure-sensitive adhesive sheet produced through coating and drying steps had a possibility of allowing an organic solvent to remain in the pressure-sensitive adhesive layer. Also, in Comparative Examples 3 and 4, since an organic solvent was used at the production, the pressure-sensitive adhesive sheet could not be rated as an environment-friendly truly desolvented tape (a pressure-sensitive adhesive tape containing substantially no organic solvent).

Also, despite oil-soluble, trade name, “TETRAD-C” may be directly added without dilution by an organic solvent at the production of the aqueous dispersion acrylic pressure-sensitive adhesive composition, but in this case, an aggregate due to dispersion failure was produced and appearance characteristics were impaired (Comparative Examples 3 and 6). On the other hand, in Example 2, since a water-diluted solution of N,N,N-tri(2,3-epoxypropyl)amine was used at the preparation of the aqueous dispersion acrylic pressure-sensitive adhesive composition, an aggregate such as undissolved matter was not observed and appearance characteristics were excellent.

While the present invention has been described in detail with reference to the specific embodiments thereof, it will be apparent to one skilled in the art that various changes and modifications can be made therein without departing from the spirit and scope of the present invention.

The present application is based on the Japanese Patent Application No. 2011-101801 filed on Apr. 28, 2011, and the entire contents thereof are incorporated herein by reference. All references cited herein are incorporated in their entirety.

What is claimed is:

1. An aqueous dispersion pressure-sensitive adhesive composition comprising:
an acrylic emulsion polymer (A); and
a compound (B),
wherein the compound (B) has a solubility in water (25° C.) of 1 g/100 g or more and has, in the molecule, at least one nitrogen atom and two or more substituents represented by the following formula (1) and bonded to the nitrogen atom: 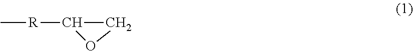
(wherein R represents a divalent group selected from the group consisting of a linear or branched alkylene group having a carbon number of 1 to 10, a phenylene group, an alkyl group-substituted phenylene group, a halogen-substituted phenylene group, and a heteroatom-containing alkylene group).

2. The aqueous dispersion pressure-sensitive adhesive composition according to claim 1, wherein the molar ratio of epoxy group of the compound (B) per mol of a functional group capable of reacting with the epoxy group of the compound (B) in the acrylic emulsion polymer (A) is from 0.003 to 3.10.

3. The aqueous dispersion pressure-sensitive adhesive composition according to claim 1, wherein the molar ratio of epoxy group of the compound (B) per mol of a functional group capable of reacting with the epoxy group of the compound (B) in the acrylic emulsion polymer (A) is from 0.015 to 0.922.

4. The aqueous dispersion pressure-sensitive adhesive composition according to claim 1, wherein said R in the formula (1) is a divalent group selected from the group consisting of a linear or branched alkylene group having a carbon number of 1 to 5, a phenylene group, an alkyl group-substituted phenylene group, a halogen-substituted phenylene group, and a heteroatom-containing alkylene group.

5. The aqueous dispersion pressure-sensitive adhesive composition according to claim 1, wherein said R in the formula (1) is a divalent group selected from the group consisting of a linear or branched alkylene group having a carbon number of 1 to 5 and a heteroatom-containing alkylene group having a carbon number of 1 to 5.

6. The aqueous dispersion pressure-sensitive adhesive composition according to claim 1, wherein said R in the formula (1) is a divalent group selected from the group consisting of a linear or branched alkylene group having a carbon number of 1 to 5.

7. The aqueous dispersion pressure-sensitive adhesive composition according to claim 1, wherein said R in the formula (1) is methylene group.

8. The aqueous dispersion pressure-sensitive adhesive composition according to claim 1, wherein said R in the formula (1) is a divalent group selected from a linear or branched alkylene group having a carbon number of 1 to 10.

9. The aqueous dispersion pressure-sensitive adhesive composition according to claim 1, wherein the number of epoxy groups contained in the compound (B) is from 3 to 5.

10. The aqueous dispersion pressure-sensitive adhesive composition according to claim 1, wherein the number of epoxy groups contained in the compound (B) is 3.

11. The aqueous dispersion pressure-sensitive adhesive composition according to claim 1, wherein the compound (B) has the solubility in water (25° C.) of 10 g/100 g or more.

12. The aqueous dispersion pressure-sensitive adhesive composition according to claim 1, wherein the compound (B) has the solubility in water (25° C.) of 30 g/100 g or more.

13. The aqueous dispersion pressure-sensitive adhesive composition according to claim 1
wherein the acrylic emulsion polymer (A) is formed of a mixture of raw material monomers comprising: a (meth)acrylic acid alkyl ester and a carboxyl group-containing unsaturated monomer, and
wherein the content of the (meth)acrylic acid alkyl ester is from 70 to 99.5 wt % and the content of the carboxyl group-containing unsaturated monomer is from 0.5 to 20 wt %, based on the total weight of the raw material monomers constituting said acrylic emulsion polymer (A).

14. The aqueous dispersion pressure-sensitive adhesive composition according to claim 1, wherein said compound (B) is N,N,N-tri(2,3-epoxypropyl)amine.

15. A pressure-sensitive adhesive sheet having a pressure-sensitive adhesive layer formed of the aqueous dispersion pressure-sensitive adhesive composition according to claim 1.
